(19) United States
(12) Patent Application Publication
(10) Pub. No.: US 2008/0206642 A1
(43) Pub. Date: Aug. 28, 2008

(54) Hydrogen Storage Material and Method for Preparation of Such a Material

(75) Inventors: Rogier Adrianus Henrica Niessen, Eindhoven (NL); Peter Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/912,310

(22) PCT Filed: Apr. 20, 2006
(86) PCT No.: PCT/IB06/51215

§ 371 Date: Oct. 23, 2007

(30) Foreign Application Priority Data
Apr. 25, 2005 (EP) 05103324.9

(51) Int. Cl. H01M 4/46; C22C 23/00

(52) U.S. Cl. 429/218.2; 420/402; 427/123

(57) ABSTRACT

The invention relates to a hydrogen storage material comprising an intermetallic compound capable of forming a hydride with hydrogen. The invention also relates to an electrochemically active material, comprising such a hydrogen storage material. The invention further relates to an electrochemical cell comprising a positive electrode and a negative electrode, said negative electrode comprising such a hydrogen storage material. Furthermore, the invention relates to electronic equipment powered by at least one electrochemical cell according to the invention. Besides, the invention relates to a method for the preparation of a hydrogen storage material according to the invention.

The invention relates to a hydrogen storage material comprising an intermetallic compound capable of forming a hydride with hydrogen. The invention also relates to an electrochemically active material, comprising such a hydrogen storage material. The invention further relates to an electrochemical cell comprising a positive electrode and a negative electrode, said negative electrode comprising a hydrogen storage material according to the invention. Furthermore, the invention relates to electronic equipment powered by at least one electrochemical cell according to the invention. Besides, the invention relates to a method for the preparation of a hydrogen storage material according to the invention.

As it is expected that a hydrogen-driven economy might be a viable solution to the shortage of fossil fuels in the future, technologies need to be developed to effectively store large amounts of hydrogen. However, the best way of storing the hydrogen is still a topic of serious debate. Up to now, hydrogen can be stored in several different ways: as compressed gas, in its liquid form, interstitially or chemically as a metal hydride (MH) and physisorbed onto highly porous materials. An important advantage of using metal hydride compounds, as compared to the low-temperature storage techniques like liquid hydrogen and physisorption, is that the hydrogen can be stored and released at moderate temperatures. Metal hydrides also provide a safe way of storage as they can be handled without extensive safety precautions, unlike compressed hydrogen gas. With this in mind, metal hydrides might be a serious storage alternative for compressed or liquid hydrogen, especially when considering mobile applications like Hybrid Electric Vehicles (HEV). It may be clear that hydride-forming materials can also be used in other applications. As the use of portable electronic equipment has increased tremendously over the last decade, research towards improved high energy density rechargeable batteries is becoming a necessity. Small electronic equipment like portable telephones, laptops, shavers, power tools, etc. are nowadays powered by either Li-ion or Nickel-Metal Hydride (NiMH) batteries. Because the energy consumption of present portable equipment is growing steadily, future NiMH batteries are required which are able to store a larger amount of energy without resulting in a weight increase. A large group of metal alloys can react with hydrogen reversibly to form metal hydrides. But only a few of them are suitable for hydrogen storage. The alloy must react and release hydrogen readily at moderate pressure and temperature, and must be stable to maintain its reactivity and capacity over a large of cycles. A known group adapted to serve as a hydrogen storage material can be represented by the formula AB₅, wherein A and B are metal elements. Examples of AB₅-type hydrogen storage alloys are MmNi_{3.5}Co_{0.7}Al_{0.7}Mn_{0.1}, MmNi_{3.6}Co_{0.7}Mn_{0.4}Al_{0.3}, SrTiO₃—LaNi_{3.76}Al_{1.24}Hn, La_{0.8}Ce_{0.2}Ni_{4.25}Co_{0.5}Sn_{0.25}, MmNi_{3.6}Co_{0.7}Al_{0.6}Mn_{0.1}, and LaNi₅. The capacity of an metal hydride (MH) electrode using an AB₅-type alloy, currently about 300 mAh/g, is approaching the limit as repeated improvements to increase material capacity have already realized very high utilization of the intrinsic capacity of the alloy.

It is an object of the invention to provide an improved hydrogen storage material with an increased hydrogen storage capacity.

This object can be achieved by providing a hydrogen storage material according to the invention, characterized in that the intermetallic compound comprises at least one alloy of magnesium and at least one metal X selected from the group: scandium, vanadium, titanium, and chromium. It has been found that with a (metastable) metal alloy with a formula MgX, wherein X represents scandium, vanadium, titanium and/or chromium, a significantly improved hydrogen storage material is provided, which is adapted to reversibly store a considerable amount of hydrogen, and thus of energy, per unit of weight, in a relatively durable, reliable and stable manner without leading to an (appreciable) increase in weight of the material. The hydrogen storage material according to the invention exhibits a relatively high energy density, id est a relatively high hydrogen storage capacity of about 1200 to 1800 mAh/g, which is commonly up to six times that of the conventional AB₅-type hydrogen storage alloy. Scandium, vanadium, titanium, and chromium are elements of similar weight. For an alloy of magnesium and scandium (MgSc), it has been determined that superior hydrogen transport properties are due to an fcc-structure (fluorite structure) of this alloy. The favorable fcc structure of the MgSc hydride most likely originates from the fact that the fcc structure of ScH₂ is retained, even when scandium is partially substituted by magnesium. Although this scandium based alloy can reversibly store a relatively large amount of hydrogen, the main drawback is the relatively high costs of scandium. It might therefore be preferable to replace scandium at least partially by the (about ten times) less expensive elements vanadium, titanium, and/or chromium.

In an advantageous embodiment, the alloy comprises 50-99 at. % magnesium and 1-50 at. % metal X, preferably 70-90 at. % magnesium and 10-30 at. % metal X, and more preferably alloy comprises 75-85 at. % magnesium and 15-25 at. % metal X. The specific amounts of the different components in the alloy are determined by balancing the hydrogen sorption kinetics and the storage capacity against each other. Magnesium as basic element of the hydrogen storage material according to the invention has a relatively high storage capacity, wherein the kinetics of charging and discharging of this material can be improved by the addition of metal X. It has been found that an alloy comprising Mg_{0.8}X_{0.2} provides for a very good balance between the hydrogen storage capacity and kinetics. The gravimetrical storage capacities of alloys with this formula were determined to be 1790 mAh/g for Mg_{0.8}Sc_{0.2}, 1750 mAh/g for Mg_{0.8}Ti_{0. 2}, 1625 mAh/g for Mg_{0.8}V_{0.2} and 1270 mAh/g for Mg_{0.8}Cr_{0.2}, corresponding to 6.67, 6.53, 6.06 and 4.74 wt % H, respectively.

It must be clear that the intermetallic compound making part of the hydrogen storage material according to the invention is by no means restricted to a binary alloy of magnesium and metal X. It might be advantageous that the intermetallic compound comprises an alloy of magnesium and at least two or more metals selected from the group scandium, vanadium, titanium, and chromium. To this end, the alloy could for example be represented by the formula Mg_{(1-(a+b))}X₍₁₎ₐX_{(2)b}, wherein X_{(1) and X}₍₂₎ are formed by different metals selected from the group scandium, vanadium, titanium, and chromium. Eventually other kind of elements could be built into the structure of the intermetallic compound.

Preferably, the hydrogen storage material further comprises at least one additive, in particular for improving the stability of the alloy, and of the metal hydride. To improve the thermodynamics of the alloy, and of the metal hydride based on this alloy, elements like, yttrium, zirconium, niobium, and nobelium could be added. In a particular preferred embodiment, the hydrogen storage material according to the present invention comprises an amount of a catalytically active material. Such a catalytically active material increases the kinetics of the hydrogen uptake of the hydrogen storage material. Advantageously, the catalytically active material comprises at least one metal selected from the group consisting of palladium, platinum, cobalt, nickel, rhodium or iridium, and/or a composition of the formula DE₃, wherein D is at least one element selected from the group consisting of molybdenum and wolfram, and E is at least one element selected from the group consisting of nickel and cobalt. Preferably, the catalytically active material comprises palladium, platinum or rhodium. It has been found that the addition of, for example, only 0.6 at. % of palladium to the alloy increases the rate of hydrogen uptake by several orders of magnitude. The addition of 1.2 at. % palladium yields even better results in hydrogen uptake.

In a preferred embodiment the alloy MgX is single-phase. Moreover, the alloy MgX has preferably a substantially (poly)crystalline structure thereby allowing enhanced diffusion of hydrogen in the crystalline alloy which leads to an improved hydrogen intercalation process. Preferably, the alloy forms a substantially homogenous layer thereby forming a so-called ‘thin film’. In a (substantially) homogeneous layer practically no pores or cavities are present within this layer, thereby making the MgX alloy suitable to be applied in e.g. an electrochemical cell (battery) which may be integrated with a housing of an electronic appliance. It must be noted that this substantially homogeneous layer may have a curved, plane geometry. In another preferred embodiment the alloy is substantially formed by grains. Both the dimensioning and shape of the grains can be arbitrary. However, the grains, preferably nanograins or micrograms, together form a bulk, in particular a powder. The grains could be molten together, though preferably said grains are formed by individual and separable particles. Said grains mutually enclose pores or cavities which makes the so-formed powder suitable to be applied within a (non-integrated) electrochemical device, such as a NiMH-battery.

The invention also relates to an electrochemically active material, characterized in that the material comprises a hydrogen storage material according to the invention. The electrochemically active material can be applied for temporarily storing relatively large amounts of hydrogen without the need of extensive safety precautions in e.g. (non-)mobile applications, like for example future fuel cell powered vehicles.

The invention further relates to an electrochemical cell comprising a positive electrode and a negative electrode, characterized in that the negative electrode comprises a hydrogen storage material according to the invention. The electrochemical cell can be used for and in various applications. An electrolyte separating both electrodes must be a good ion conductor, but it must be an isolator for electrons in order to prevent self-discharge of the device. As an electrolyte liquid, use can be made of electrolytes, such as an aqueous solution of KOH. Such a solution is a good ion conductor, and the metal hydrides are stable in it. The electrolyte may also be present in the gel or solid state. Use is most preferably made of transparent solid-state electrolytes, because of the simplicity of the device; they prevent sealing problems, and the device is easier to handle. Both solid inorganic and organic compounds can be used. Examples of inorganic electrolytes, which are good proton (H⁺) conductors, are hydrated oxides such as Ta₂O₅.nH₂O, Nb₂O₅.nH₂O, CeO₂.nH₂O, Sb₂O₅.nH₂O, Zr(HPO₄)₂.nH₂O and V₂O₅.nH₂O, H₃PO₄(WO₃)₁₂.29H₂O, H₃PO₄(MoO₃)₁₂.29H₂O, [Mg₂Gd(OH)₆]OH.2H₂O and anhydrous compounds such as KH₂PO₄, KH₂AsO₄, CeHSO₄, CeHSeO₄, Mg(OH)₂ and compounds of the type MCeO₃ (M=Mg, BA, Ca, Sr), in which a part of Ce has been substituted by Yb, Gd or Nb. Also glasses may be used, such as alkali-free zirconium phosphate glass. Examples of good ion (H₃O⁺) conductors are HUO₂PO₄.4H₂O and oxonium β-alumina. Examples of good H⁻-ion conductors are CaCl₂/CaH₂, Ba₂NH and SrLiH₃. An example of a solid organic electrolyte is poly(2-acrylamido-2-methyl-propane-sulphonic acid).

The invention furthermore relates to electronic equipment powered by at least one electrochemical cell according to the invention. As aforementioned, the hydrogen storage material making part of the negative electrode can be integrated with a housing of said electronic equipment.

Besides, the invention relates to a method according to the preamble, comprising the step of: A) formation of an intermetallic compound comprising at least one alloy of magnesium and at least one metal X selected from the group scandium, vanadium, titanium, and chromium. Preferably, the alloy formed by the method according to the invention is substantially crystalline and single-phased. During step A) the intermetallic compound is preferably formed out of an atomic mixture of magnesium atoms and metal X atoms. In this case, the alloy MgX is formed in a metallurgical manner out of atoms of magnesium and metal X. Thus, no hydrogen is needed during this formation, which makes the preparation of the alloy relatively simple, cheap, and safe. The atomic mixture can be (part of) of gaseous, liquid or solid nature dependent of the preparation technique used. To avoid a significant increase of temperature during formation of the alloy, the alloy is preferably cooled by cooling means. In a preferred embodiment during step A) formation of the intermetallic compound is realized by means of a substrate on which the intermetallic compound is formed. Said substrate—preferably made of quartz, metal, or silicon—is preferably cooled to avoid a situation of overheating. In an advantageous embodiment step A) is carried out at a temperature of between 0 and 40 degrees Celsius, preferably between 10 and 30 degrees Celsius, and more preferably about room temperature ((about) 20 degrees Celsius).

In a preferred embodiment of the method according to the invention, step A) is carried out by means of at least one techniques selected from the group: electron-beam deposition, melt spraying, melt spinning, splat cooling, vapor quenching, gas atomization, plasma spraying, due casting, ball-milling, and hydrogen induced powder formation. These techniques per sé are well-known for a person skilled in the art. Most of these techniques are based on instantaneously cooling down of a gaseous or liquid atomic mixture to form the alloy of magnesium and metal X.

The preparation of the hydrogen storage material according to the invention will be elucidated in the non-limitative illustrative experiment described and discussed hereinafter.

### EXPERIMENT

The Mg_{0.8}X_{0.2} (X=Sc, Ti, V, Cr) thin films were manufactured using electron-beam deposition (base pressure between 10⁻⁷ and 2*10⁻⁷ mbar). During the deposition the substrates were kept at room temperature. The thin films, having a nominal thickness of 200 nm, were deposited on quartz substrates (Ø20 mm). An in-house procedure was used to clean the substrates. A Pd catalyst layer, 10 nm thick, was deposited on top of the Mg_{0.8}X_{0.2} thin films. Rutherford Backscattering Spectroscopy (RBS) was used to check the film composition. Based on these measurements it was concluded that the Mg_{0.8}X_{0.2} composition was uniform throughout the film. Calculations regarding the hydrogen storage capacity are solely based on the RBS measurements. As a maximum deviation in the hydrogen storage capacity of the Mg_{0.8}X_{0.2} compound can occur of no more than 3%, no correction is made for the Pd cap layer. X-Ray Diffraction (XRD) was used to identify the crystallographic phases of the freshly prepared samples.

A three-electrode set-up, of which the details are described elsewhere, was used to electrochemically characterize the thin films. The measurement set-up was thermostated to 25° C. and filled with 6 M KOH electrolyte. The potential of the thin film electrode was measured with respect to a Hg/HgO reference electrode (Koslow Scientific Company) filled with 6 M KOH solution. Special care was taken to prevent surface poisoning of the thin film electrodes, which seriously affects the electrochemical response.

Galvanostatic measurements and Galvanostatic Intermittent Titration Technique (GITT) were performed using an Autolab PGSTAT30 (Ecochemie B.V., Utrecht, the Netherlands). Unless stated otherwise, the cut-off voltage applied during all galvanostatic experiments was set to 0 V vs Hg/HgO and all potential values are given vs Hg/HgO (6 M KOH).

Hydrogenation of the MgX thin films was achieved by electrochemical means in an aqueous electrolyte. In order to protect the films from corrosion and to catalyse hydrogen sorption, the films were capped with a 10 nm Pd topcoat. Thin films were used in this study because they can serve as a 2D model system, enabling accurate determination of material kinetics, thermodynamics and hydrogen transport phenomena.

Electrochemical hydriding/dehydriding of the thin film can be described by a two-step mechanism. The first step is the charge transfer reaction at the Pd/KOH interface, which can be represented by

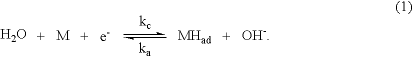

Once adsorbed hydrogen atoms (H_{ad}) are formed at the electrode surface, they are absorbed (H_{abs}) by the Pd topcoat and subsequently by the underlying MH according to

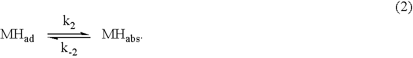

As, according to reaction 1, one electron is transferred for each hydrogen atom inserted into or extracted from the hydride-forming compound, Coulomb counting can be used to determine the hydrogen content. Electrochemical hydrogen loading can thus be used to accurately control the hydrogen content in the MgX thin film electrodes.

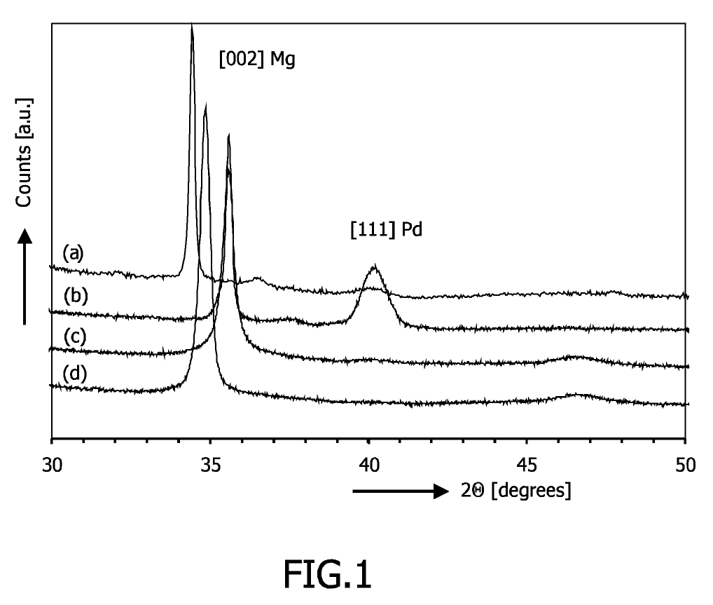

FIG. 1 shows the XRD spectra of Mg_{0.8}X_{0.2} thin films freshly prepared by means of electron-beam deposition (Mg_{0.8}Sc_{0.2}, curve (a); Mg_{0.8}Ti_{0.2}, curve (b); Mg_{0.8}V_{0.2}, curve (c); Mg_{0.8}Cr_{0.2}, curve (d)). All four thin films show a strong preferred orientation, which is characteristic for thin films. The strongest reflection belongs to the [002] orientation of hcp Mg. For all four compounds, this peak is shifted with respect to pure Mg (34.5°2θ) due to the fact that Sc, Ti, V or Cr host atoms are incorporated into the Mg-structure. Taking the Mg_{0.8}Ti_{0.2} thin film as an example (FIG. 1, curve (b)), it can be seen that the main peak has shifted to higher angle. This shift is brought about by partial substitution of Ti, which has a smaller molar volume than Mg, causing the lattice to shrink and the peak to shift.

As no reflections were observed that could be linked to the hcp structure of pure Sc or Ti, or the bcc structure of either pure V or Cr, it is assumed that a single-phase solid solution of Sc, Ti, V or Cr in Mg was formed. Besides the responses of the Mg_{0.8}X_{0.2} layers, reflections were measured that could be linked to the Pd topcoat. It seems that the orientation of the Pd is strongly dependent on the degree of orientation of the underlying Mg_{0.8}X_{0.2} layer. For the Mg_{0.8}Ti_{0.2} thin film a strong reflection is present of [111] oriented fcc-structured Pd. In the cases of Mg_{0.8}Sc_{0.2}, Mg_{0.8}V_{0.2} and Mg_{0.8}Cr_{0.2} the Pd topcoat is still oriented in the [111] direction, but the reflection is much weaker and therefore hard to distinguish in the XRD data. It should be noted that RBS measurements (not shown here) indicated that all Pd was indeed present as a separate layer on top of the Mg_{0.8}X_{0.2} layers and not dissolved into the Mg structure.

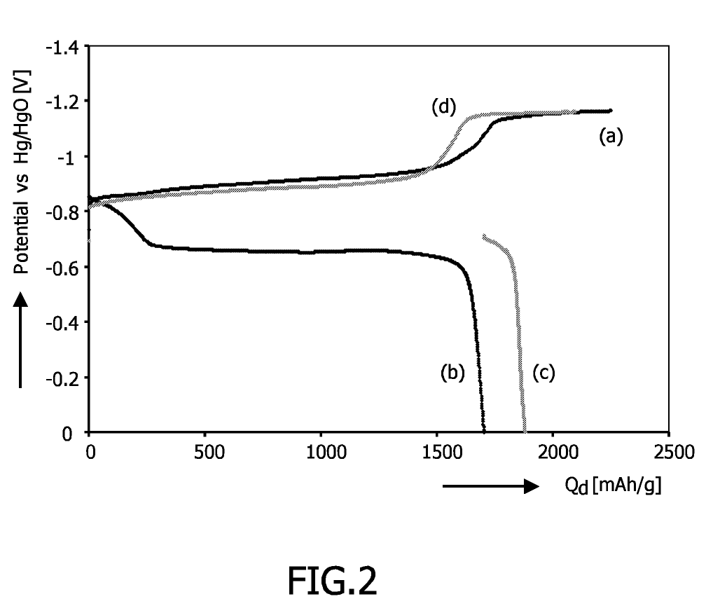

The electrochemical response of the Mg_{0.8}X_{0.2} thin films was compared during galvanostatic hydrogen insertion (charging) and hydrogen extraction (discharging). FIGS. 2 to 5 show the charge, discharge and deep-discharge curves of each of the four compounds. Currents were used of −0.6 mA, +0.12 mA and +0.012 mA, respectively. It should be noted that in these experiments the layers were first fully hydrogenated (curves (a)) and hereafter allowed to reach equilibrium under open-circuit conditions. Then the layers were discharged until the cut-off potential was reached (curves (b)), after which the electrode was allowed to equilibrate for 1 hour. Subsequently, deep-discharging was performed (curves (c)). Finally the electrodes were again charged to the fully loaded state (curves (d)).

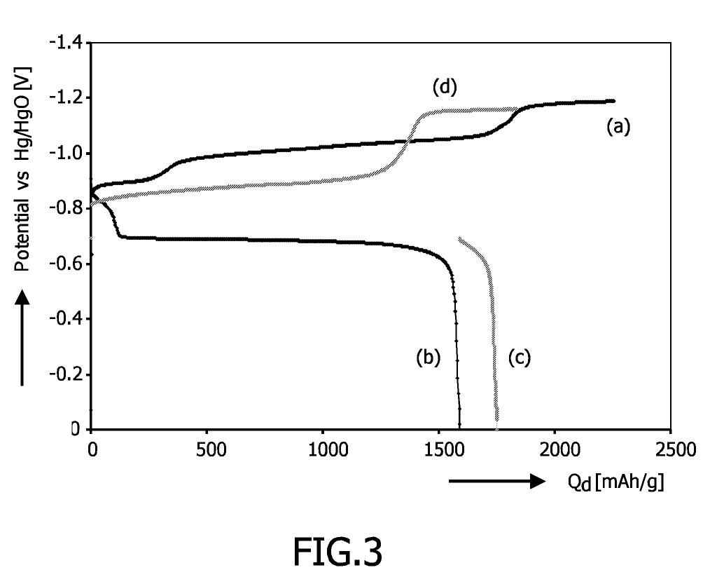

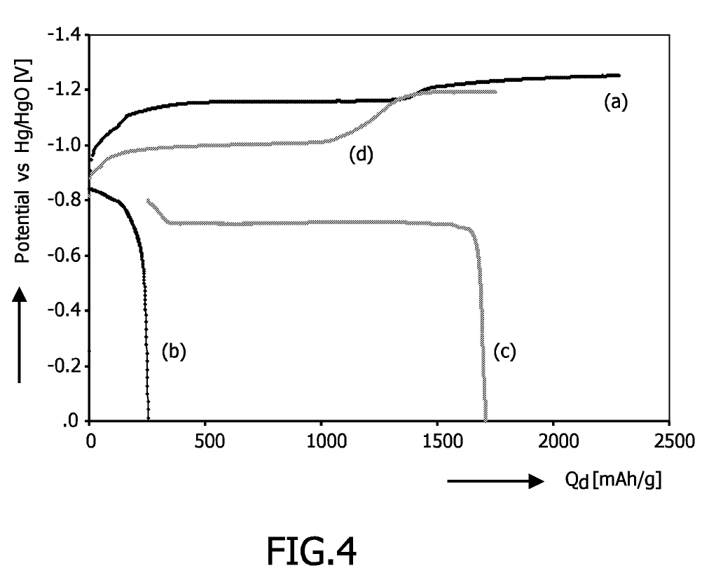

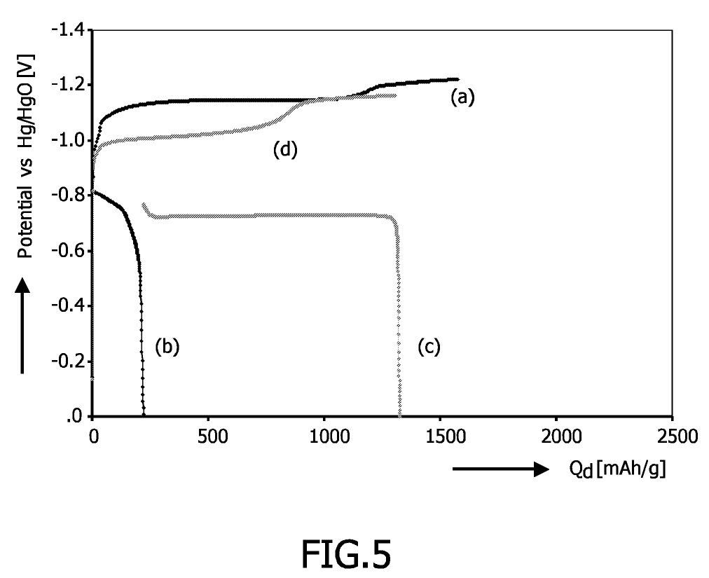

Focusing on first-time charging of the Mg_{0.8}Sc_{0.2} and Mg_{0.8}Ti_{0.2} compounds, it is that clear that the entire curve is comprised of two sloping plateaus (see FIGS. 2 and 3, curves (a)). Based on the total amount of material present in each layer, the first plateau roughly corresponds to hydrogenation of Sc and Ti to ScH₂ and TiH₂, respectively. Analogously, the second plateau could explain hydrogenation of Mg to MgH₂. First-time charging of the Mg_{0.8}V_{0.2} and Mg_{0.8}Cr_{0.2} compounds shows a more complex response, especially during the early stage of charging (see FIGS. 4 and 5, curves (a)). Most notably, the main plateau, linked to hydrogen intercalation, is more flat and manifests itself at a more negative potential (−1.00 V to −1.15 V) as compared to the MgSc and MgTi compounds (−0.8 V to −1.1 V).

The discharge curves of all Mg_{0.8}X_{0.2} compounds (depicted in FIGS. 2 to 5, curves (b)) reveal a sloping response when the film is in the hydrogen-rich state. This response can be linked to a solid solution behaviour, which clearly depends on the metal X. Furthermore, a very flat plateau at about −0.72 V can be seen for the Mg_{0.8}Sc_{0.2} and Mg_{0.8}Ti_{0.2} compounds, indicative of a two-phase coexistence (see FIGS. 2 and 3, curves (b)). The Mg_{0.8}V_{0.2} and Mg_{0.8}Cr_{0.2} compounds, however, cannot be discharged this effectively using the same current and no plateau is observed (see FIGS. 4 and 5, curves (b)). Subsequent deep-discharging results in the fact that all four compounds can be completely discharged. In the case of the Mg_{0.8}Sc_{0.2} and Mg_{0.8}Ti_{0.2} compounds the largest part of the hydrogen was already extracted at high current, effectively only showing a second solid solution behaviour at the hydrogen-depleted state (FIGS. 2 and 3, curves (c)). The lower current used during deep-discharging enabled the release of the remaining hydrogen from the Mg_{0.8}V_{0.2} and Mg_{0.8}Cr_{0.2} compounds (FIGS. 4 and 5, curves (c)). The potential response now also shows a two-phase coexistence for these materials, similar to that of the Mg_{0.8}Sc_{0.2} and Mg_{0.8}Ti_{0.2} compounds. It is clear that the rate capability of the Mg_{0.8}V_{0.2} and Mg_{0.8}Cr_{0.2} materials is substantially lower than that of the Mg_{0.8}Sc_{0.2} and Mg_{0.8}Ti_{0.2} compounds.

The hydrogen storage capacity of the four compounds presented in this contribution was determined by adding the measured discharge capacity of the first discharge and the first deep-discharge (see FIGS. 2 to 5, curves (b) and (c)). The results are listed in Table 1 and are given as gravimetrical storage capacity in both [mAh/g] and [wt % H]. The measured hydrogen storage capacities of the Mg_{0.8}X_{0.2} compounds is sometimes close to six times that of commercially used AB₅-type materials.

If the responses are compared, measured when charging of the thin films for the first and second time, other interesting facts come to light (see FIGS. 2 to 5, curves (a) and (d)). It is evident that the amount of charge (or hydrogen) that can be stored in the material when charged for the second time is less than during the first time. This shows that part of the hydrogen stored during the first charging step is irreversibly incorporated and cannot be released under the experimental conditions applied. The curves corresponding to the second time the Mg_{0.8}Sc_{0.2} and Mg_{0.8}Ti_{0.2} compounds are charged only show a single large plateau, indicating that hydrogen must have been irreversibly bonded to Sc and Ti initially (see FIGS. 2 and 3, curves (a) and (d)). This is plausible, as it is known from the prior art that the heats of formation of ScH₂ and TiH₂ are reported to be −100 kJ/mol H and −70 kJ/mol H, respectively. The curves corresponding to second time the Mg_{0.8}V_{0.2} and Mg_{0.8}Cr_{0.2} film are charged show a similar trend and less hydrogen could be intercalated (FIGS. 4 and 5, curves (a) and (d)). The most notable difference between the first and second time the compounds are charged is, however, the significant reduction of the overpotential (η). η can be represented by

η=IR+ηₖᵢₙ+η_{dif} (3)

where IR is the Ohmic drop (assumed to be negligible), ηₖᵢₙ is the kinetic overpotential and η_{dif} the diffusion overpotential. Impedance measurements (not shown here) indicate that the reduction in η can be attributed to a decrease in ηₖᵢₙ, which is brought about by improved surface kinetics. As these kinetics are directly linked to the nature of the interface at which the charge transfer takes place (reaction 1), it has to be concluded that changes have occurred at the Pd/KOH interface.

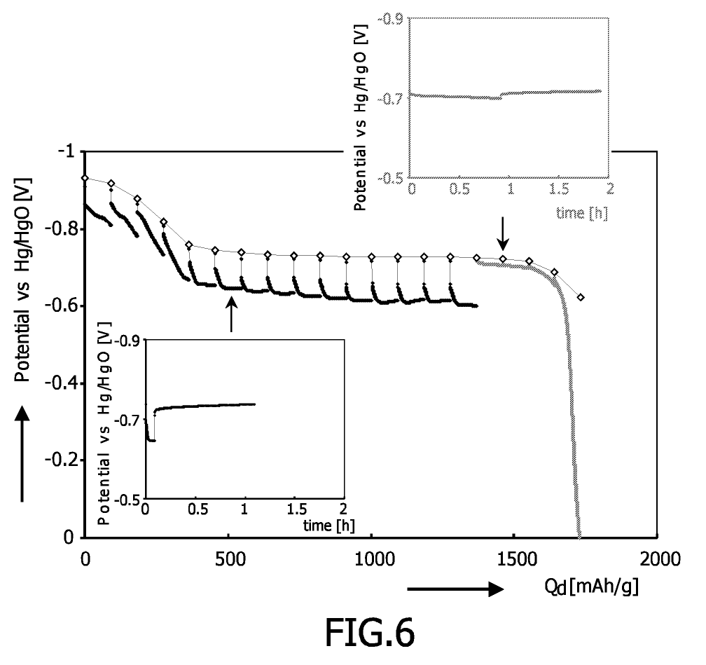

The isotherms of the Mg_{0.8}X_{0.2} compounds were determined electrochemically by means of GITT measurements. The thin films were first galvanostatically charged to their fully hydrogenated state using a current of −0.6 mA. Subsequently, the electrodes were allowed to equilibrate for 1 hour. Hereafter, the Mg_{0.8}Sc_{0.2} and Mg_{0.8}Ti_{0.2} electrodes were discharged by means of GITT using a current of +0.12 mA during the first fifteen and +0.012 mA during the last few pulses. The Mg_{0.8}V_{0.2} and Mg_{0.8}Cr_{0.2} thin films were, however, discharged using a current of only +0.012 mA. After each current pulse all the electrodes were allowed to equilibrate for 1 hour. FIG. 6 shows the obtained equilibrium curve as well as the potential response of the Mg_{0.8}Sc_{0.2} compound during each current pulse. It is clear that η remains nearly constant throughout the entire discharge process, only to increase significantly at the very end of the discharge process. This behaviour is as expected as the thin film reaches its hydrogen-depleted state. After the electrodes where fully discharged, the described procedure was reversed and the electrodes were charged to the fully hydrogenated state using GITT. The same parameters were applied except for the fact that currents were used of −0.12 mA and −0.012 mA, respectively.

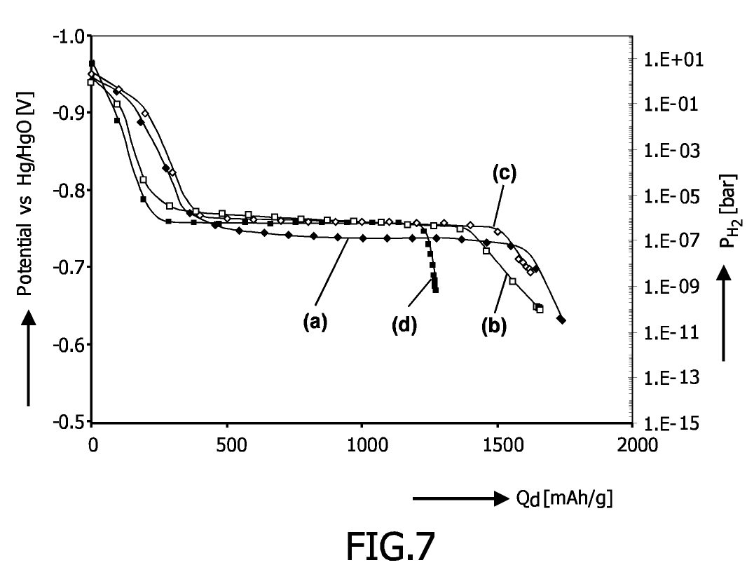

The equilibrium discharge curves of all the Mg_{0.8}X_{0.2} compounds are depicted in FIG. 7. As already expected from the galvanostatic responses shown before (see FIGS. 2 to 5), the isotherms show a similar behaviour for all Mg_{0.8}X_{0.2} compounds. Clearly, the initial solid solution up to a discharge capacity of about 400 mAh/g seems to be dependent on X in MgX. This solid solution has the most negative equilibrium potential for the Mg_{0.8}Sc_{0.2} and Mg_{0.8}V_{0.2} compounds, which can be understood when the correlation between equilibrium potential (E^{eq}) and the heat of formation (ΔH_{f}) is used. ΔH_{f} is directly linked to the partial hydrogen pressure (P_{H}_{₂}) via

$$Δ {H}_{f} = \frac{RT}{2} [ ln {P}_{{H}_{2}} - \frac{{S}_{{H}_{2}}^{0}}{R} ] . \qquad ( 4 )$$

where R is the gas constant; T the temperature and S_{H}_{₂}⁰ the standard molar entropy of hydrogen gas (130.8 J/K mol H₂). Furthermore, P_{H}_{₂} can be expressed as the E^{eq} through

$${E}_{MH}^{eq} = - 0.931 - \frac{RT}{2 F} ln \frac{{P}_{{H}_{2}}}{{P}_{ref}} . \qquad ( 5 )$$

in which F is the Faraday constant and P_{ref} the reference pressure of 1 bar. Combining Eqs. 4 and 5 shows that a more negative value of E_{MH}^{eq} corresponds to a less negative value of ΔH_{f}. This is indeed in line with the expected values of ΔH_{f}, based on known experimental data for the reversible transition of ScH₃ to ScH₂. Here it was shown that systematically increasing the amount of Sc in MgSc extends the initial solid solution.

For VHₓ the situation is somewhat more complex. It is known that VH₂ (γ-phase) is unstable at room temperature, but that low-pressure hydrides exist with compositions up to VH (α- and β-phases). These have ΔH_{f} values of around −20 kJ/mol H and lower, which correspond to the experimentally observed equilibrium pressures of the initial solid solution of the Mg_{0.8}V_{0.2} compound.

The main plateau in the isotherms is situated at −0.75 V for all the compounds, except for Mg_{0.8}Sc_{0.2}, which has a somewhat more positive potential at around −0.74 to −0.72 V. ΔH_{f} corresponding to these plateaus are −37 kJ/mol H and −40 kJ/mol H for Mg_{0.8}X_{0.2} (X=Ti, V, Cr) and Mg_{0.8}Sc_{0.2}, respectively (using Eqs. 4 and 5). It is rather remarkable that, with the exception of Mg_{0.8}Sc_{0.2}, ΔH_{f} seems to be unaffected by X in MgX. Moreover, ΔH_{f} seems to be identical to that reported for the transition from Mg to MgH₂.

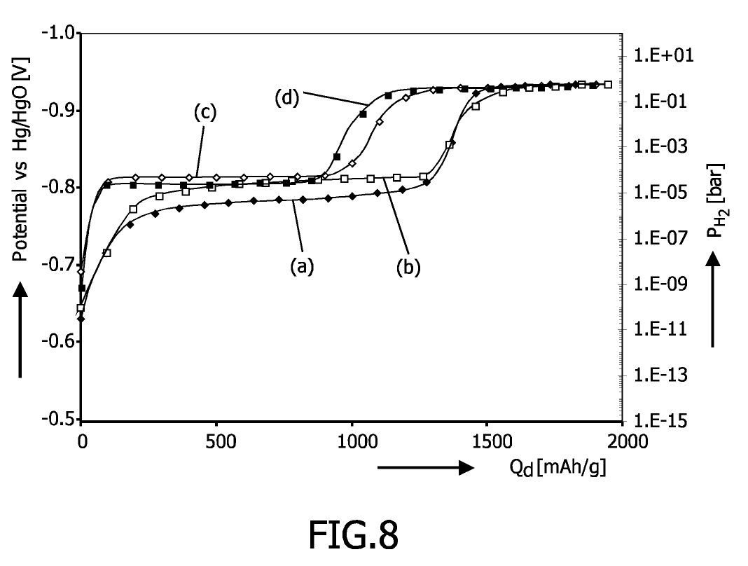

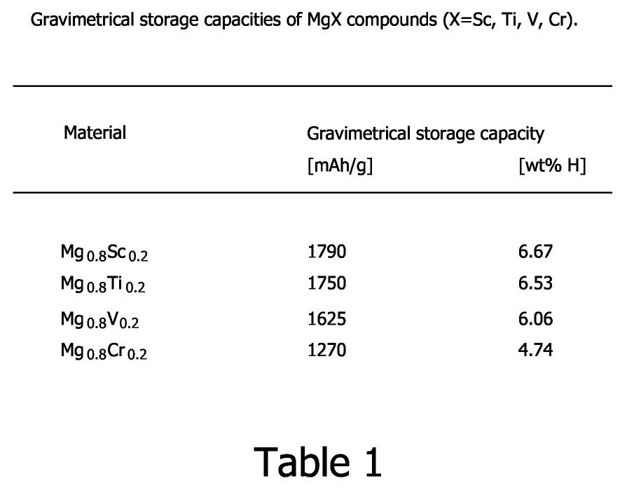

FIG. 8 shows the equilibrium curves of the Mg_{0.8}X_{0.2} compounds during charging. Similar to its discharge isotherm (see FIG. 7, curve (a)), the charging isotherm of Mg_{0.8}Sc_{0.2} has the most positive equilibrium potential (FIG. 8, curve (a)). The gradually sloping plateau is situated at potential values of −0.76 V to −0.79 V, corresponding to −36 kJ/mol H to −33 kJ/mol H, respectively. This difference in measured equilibrium potential during discharging and charging points to hysteresis, which is frequently observed for both thin film and bulk hydrogen storage materials. The origin of this hysteresis might be attributed to different stress states, induced by (uniaxial) expansion of the lattice, during charging and discharging. Unlike the practically superimposing equilibrium plateaus during discharging (see FIG. 7, curves (b) to (d)), the plateau value during charging of the Mg_{0.8}X_{0.2} (X=Ti, V, Cr) compounds appear to be slightly dissimilar (FIG. 8, curves (b) to (d)). The Mg_{0.8}V_{0.2} thin film exhibits the most negative plateau at around −0.805 V, corresponding to −31 mol H. Comparing FIGS. 7 and 8, it is interesting to note that all Mg_{0.8}X_{0.2} compounds show a similar hysteresis effect between discharging and charging. In all cases the difference in plateau value is approximately 50 mV or, according to Eq. 5, a factor 50 in plateau pressure.

It should be noted that the above-mentioned embodiments and experiment illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Hydrogen storage material comprising an intermetallic compound capable of forming a hydride with hydrogen, characterized in that the intermetallic compound comprises at least one alloy of magnesium and at least one metal X selected from the group: scandium, vanadium, titanium, and chromium.

2. Hydrogen storage material according to claim 1, characterized in that the alloy comprises 50-99 at. % magnesium and 1-50 at. % metal X.

3. Hydrogen storage material according to claim 2, characterized in that the alloy comprises 70-90 at. % magnesium and 10-30 at. % metal X.

4. Hydrogen storage material according to claim 3, characterized in that the alloy comprises 75-85 at. % magnesium and 15-25 at. % metal X.

5. Hydrogen storage material according to claim 4, characterized in that the alloy comprises Mg_{0.8}X_{0.2}.

6. Hydrogen storage material according to claim 1, characterized in that the intermetallic compound comprises an alloy of magnesium and at least two metals selected from the group scandium, vanadium, titanium, and chromium.

7. Hydrogen storage material according to claim 1, characterized in that the hydrogen storage material further comprises at least one additive.

8. Hydrogen storage material according to claim 7, characterized in that said additive is formed by an catalytically active material.

9. Hydrogen storage material according to claim 8, characterized in that the catalytically active material comprises is selected from the group palladium, platinum, or rhodium.

10. Hydrogen storage material according to claim 1 characterized in that the alloy has a substantially polycrystalline structure.

11. Hydrogen storage material according to claim 1, characterized in that the alloy forms a substantially homogenous layer.

12. Hydrogen storage material according to claim 1, characterized in that the alloy is substantially formed by grains together forming a powder.

13. Electrochemically active material, characterized in that the material comprises a hydrogen storage material as claimed in claim 1.

14. Electrochemical cell comprising a positive electrode and a negative electrode, characterized in that the negative electrode comprises a hydrogen storage material as claimed in claim 1.

15. Electronic equipment powered by at least one electrochemical cell, characterized in that the at least one electrochemical cell is an electrochemical cell as claimed in claim 14.

16. Method for the preparation of a hydrogen storage material according to claim 1, comprising the step of:
formation of an intermetallic compound comprising at least one alloy of magnesium and at least one metal X selected from the group scandium, vanadium, titanium, and chromium.

17. Method according to claim 16, characterized in that during step A) the intermetallic compound is formed out of an atomic mixture of magnesium atoms and metal X atoms.

18. Method according to claim 16, characterized in during step A) formation of the intermetallic compound is realized by means of a substrate on which the intermetallic compound is formed.

19. Method according to claim 16, characterized in that step A) is carried out at a temperature of between 0 and 40 degrees Celsius.

20. Method according to claim 16, characterized in that step A) is carried out by means of at least one technique selected from the group: electron-beam deposition, melt spraying, melt spinning, splat cooling, vapor quenching, gas atomization, plasma spraying, due casting, ball-milling, and hydrogen induced powder formation.
